(19) United States
(12) Patent Application Publication
(10) Pub. No.: US 2010/0037469 A1
(43) Pub. Date: Feb. 18, 2010

(54) Seaweed Trimmer

(76) Inventor: Richard A. Chubb, Voorhees, NJ (US)

Correspondence Address: Francis C. Hand, Esq.;c/o Carella, Byrne, Bain, Gilfillan, Cecchi,, Stewart & Olstein, 5 Becker Farm Road, Roseland, NJ, 07068, US

(21) Appl. No.: 12/228,339

(22) Filed: Aug. 12, 2008

(51) Int. Cl. A01G 3/00; A01G 33/00

(52) U.S. Cl. 30/198; 30/199; 30/216

(57) ABSTRACT

The seaweed trimmer is constructed of three main components, i.e. a gasoline powered drive motor assembly, a removably mounted extension mount and a trimmer unit that are operably connected to each other. The trimmer unit includes a pair of cutter strips that are reciprocal relative to each other for cutting seaweed and that are mounted in an articulated manner to be adjusted into parallel relation with a water bottom.

This invention relates to a seaweed trimmer.

As is known, the bottoms of bodies of water, such as lakes, ponds, bays and the like, have growths of seaweed and grasses that can become a cause of concern for swimmers, boaters and the environment in general. In the case of swimmers, the feel of the seaweed and grass is unacceptable; and, in severe cases, can lead to injury or drowning, if an inexperienced swimmer were to become entangled in seaweed. In the case of boaters, engines, propellers and other underwater gear can become fouled in the seaweed and grasses. In the case of the environment, the seaweed and grasses have clogged the waterways to navigation, fish and amphibians.

Various attempts have been made to limit the growth of seaweed and grasses in waterways. Traditional methods for seaweed control have involved cutting with a seaweed rake, manually or mechanically pulling out the seaweed (including the roots) and chemical poisoning. In many cases, pulling out the seaweed and/or poisoning have been banned by State Regulations.

Accordingly, it is an object of the invention to provide a relatively simple device for trimming seaweed and sea grasses from the bottoms of a body of water.

It is another object of the invention to provide an environmentally friendly device for trimming seaweed and sea grasses from the bottom of a body of water.

It is another object of the invention to provide a device for trimming seaweed and sea grasses from the bottom of a body of water that is easy to use by one adult operator.

It is another object of the invention to provide a device for trimming seaweed and sea grasses from the bottom of a body of water that is easy to maintain.

Briefly, the invention provides a seaweed trimmer for trimming seaweed and sea grass (“seaweed”) from waters, such as lakes, ponds, bays and the like. The trimmer is manually operable and is sized to be used by one person standing in the water in which the seaweed is to be trimmed or standing on a floating platform, boat or permanent pier or dock that allows the person to be in close proximity to the bottom of the body of water containing the seaweed to be trimmed.

The trimmer is comprised of a drive motor assembly, at least one extension mount (shaft) and a trimmer unit that are operably-connected to each other

The drive motor assembly is gasoline driven rather than being electrically driven in order to be used in water and has a rotatable drive shaft.

The extension mount is removably coupled to the drive motor assembly and is of a suitable length to be able to submerge the trimmer unit to a desired depth of water and to space the trimmer unit a safe distance from the legs of the operator. This extension mount includes a tubular housing and a rotatably mounted shaft within the housing coupled to the drive shaft of the drive motor assembly. Also, several extension mounts may be connected together in order to provide for use of the trimming unit at greater depths than usual, or if the operator seeks to stand on a work platform, boat, pier or other elevated structure above the body of water containing the seaweed to be trimmed.

The trimmer unit is removably coupled to the extension mount so that different lengths of extension mounts may be employed. The trimmer unit has an elongated handle, a rotatable shaft within the handle coupled to the shaft of the extension mount for rotation therewith and a trimming means for cutting seaweed.

The trimming means is constructed in a known manner with a pair of elongated digitated strips disposed in overlapping relation and a coupling means connected between the rotatable shaft within the handle and one of the digitated strips for reciprocating the digitated strip relative to the other digitated strip for cutting seaweed disposed between the pair of strips.

In addition, the coupling means of the trimmer unit is articulated on the handle for pivoting the trimming means relative to the handle and extension shaft so that the trimming means can be angled relative to the operator's height to allow a “close shave” to the bottom of the body of water being trimmed of seaweed. To this end, a lever or similar locking knob is connected to the coupling means for manual pivoting of the trimming unit relative to the handle.

For ease of use, the seaweed trimmer may be provided with a strap that is connected to the drive motor assembly for suspending the seaweed trimmer from the body of the operator and for helping to prevent the gasoline-powered engine from submerging below the surface of the water. Also, a rigid handle may be adjustably mounted on the drive motor assembly for manual grasping thereof during manual operation of the seaweed trimmer.

In order to reduce the risk of corrosion, a corrosion inhibiting grease or similar lubricant is packed or sprayed into each of drive motor assembly, extension mount and trimmer unit. Alternatively, or in addition, at least the extension mount and the trimmer unit are made of corrosion-resistant materials, such as a suitable plastic, stainless steel, and the like.

These and other objects and advantages of the invention will become more apparent from the following detailed description taken in conjunction with the accompanying drawings wherein:

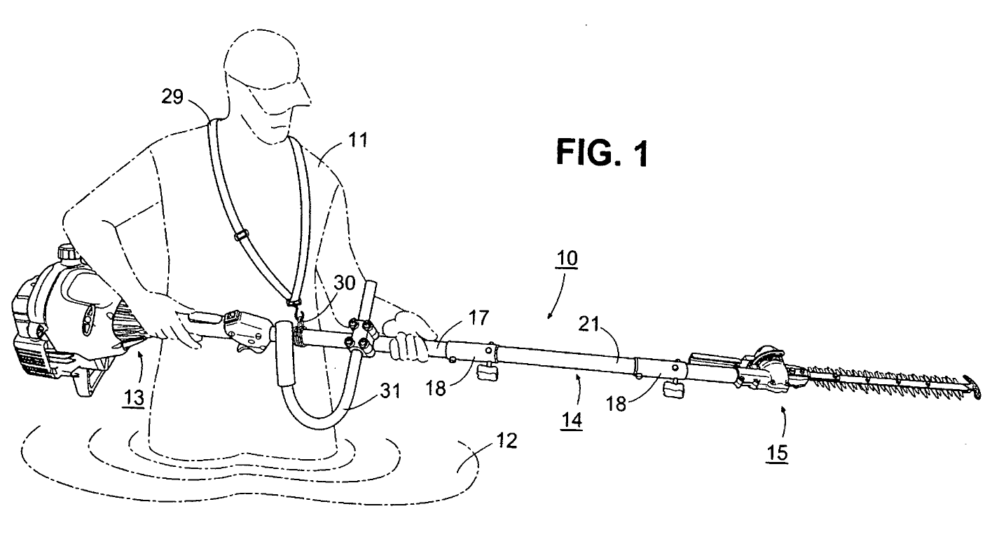

FIG. 1 illustrates a perspective view of the seaweed trimmer in use by an adult operator;

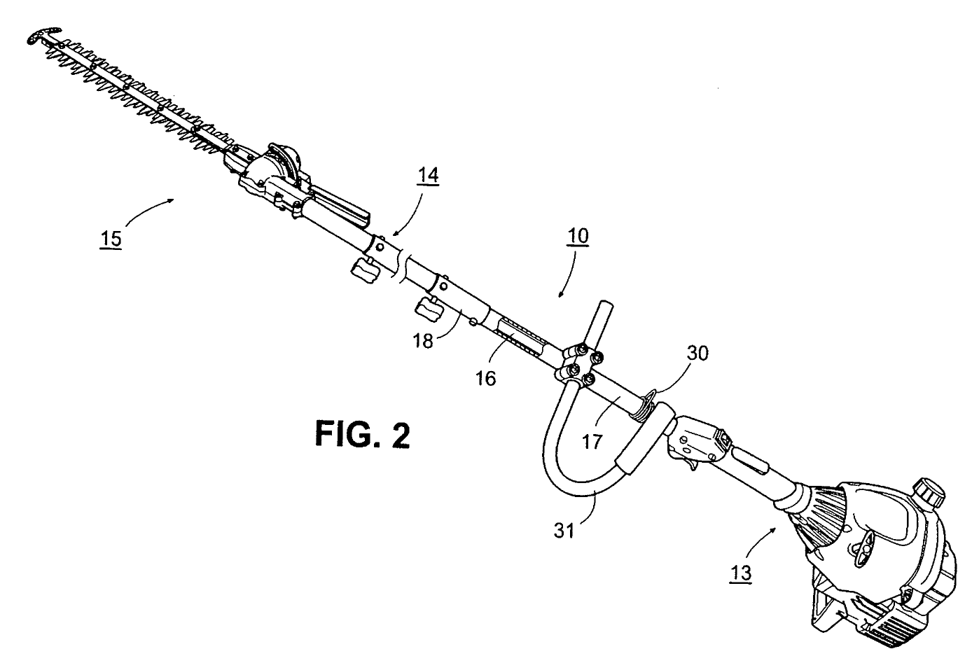

FIG. 2 illustrates an exploded view of the seaweed trimmer of FIG. 1;

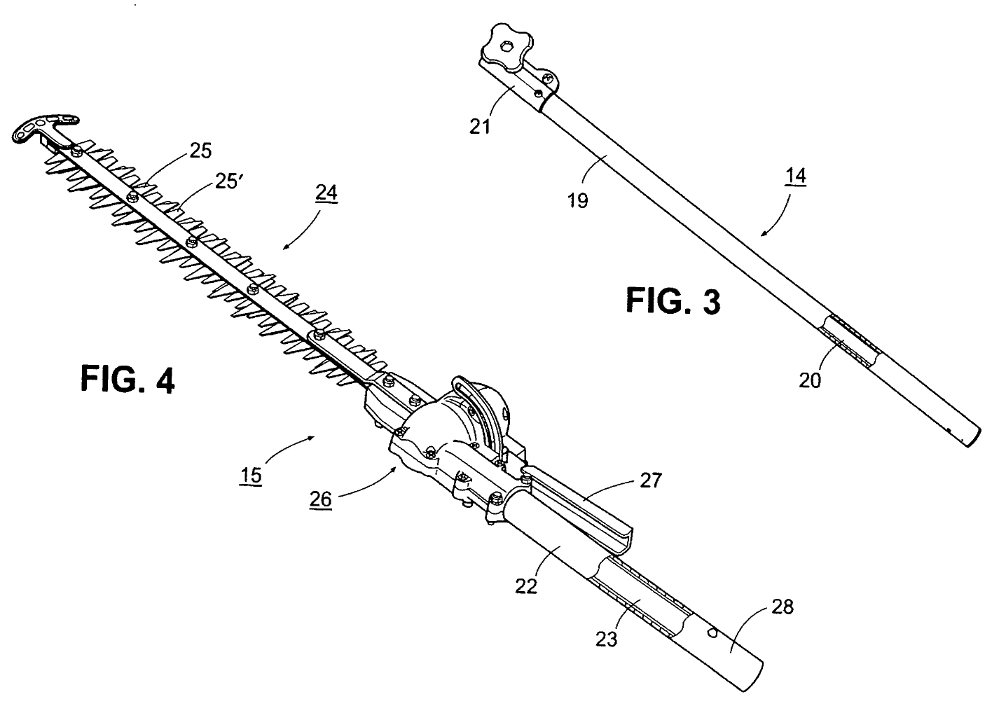

FIG. 3 illustrates a perspective view of the extension mount of the seaweed trimmer of FIG. 2; and

FIG. 4 illustrates a perspective view of the trimmer unit of the seaweed trimmer of FIG. 2.

Referring to FIG. 1, the seaweed trimmer 10 is made from commercially available parts and is constructed to be used manually by an adult operator 11 in a body of water 12 in which the operator 11 may stand. Alternatively, the seaweed trimmer 10 may be constructed to be used manually by an operator 11 standing on a pier (not shown) or in a boat (not shown) or on a floating work platform (not shown) and for use at different water depths.

As shown, the seaweed trimmer 10 is comprised of a drive motor assembly 13, an extension mount 14 and a trimmer unit 15 that are operably connected to each other.

Referring to FIG. 2, the drive motor assembly 13 is made from a commercially available Troy-Bilt 2-Cycle Gasoline Trimmer/Brushcutter, Model TB90BC that is gasoline driven and has a rotatable drive shaft 16 within a tubular housing 17 and a coupler 18 at the end of the housing 17. The remaining parts of the commercially available trimmer/brush cutter not required for driving the shaft 16 are not further described.

Use is made of a gas driven motor assembly rather than using an electrically driven assembly to avoid electrical shock in water and to provide the operator with a large operating area without the restrictions associated with a tethered powered source, whether electric or air. Such a gas driven motor assembly may be modified to permit the assembly to operate briefly underwater, in the event the operator accidentally lowered the assembly into the water. For example, a floating air-intake/exhaust tube, and the like may be used to accommodate operation while submerged.

Use may be made of a compressed-air-operated type of similar reciprocating “saw” on a tether. With compressed air operation, an operator could “submerge” the unit without the risks of submerging a gasoline-powered unit.

Referring to FIG. 3, the extension mount 14 is made from a commercially-available Troy-Bilt Pole Saw TBPS extension mount and is removably coupled to the drive motor assembly 13 and is of a suitable length to be able to submerge the trimmer unit 15 to a desired depth of water and to space the trimmer unit 15 a safe distance from the legs and feet of the operator 11.

The extension mount 14 includes a tubular housing 19 that is sized to be fitted into the coupler 18 of the drive motor assembly 13 as well as a rotatably mounted shaft 18 within the housing 19. The distal end of the housing 19 is provided with a known coupler 21 for securing one end of the trimmer unit 15 in the extension mount 14.

Several extension mounts may be connected together in order to provide for use of the trimming unit 13 at greater depths than usual.

Referring to FIG. 4, the trimmer unit 15 is made from a commercially available Troy-Bilt Articulating Hedge Trimmer TBAH and is removably coupled to the extension mount 14 so that different lengths of extension mounts may be employed. The trimmer unit 15 has an elongated handle 22, a rotatable shaft 23 within the handle 22 that can be coupled to the shaft 20 of the extension mount 14 for rotation therewith and a trimming means 24 having a pair of elongated digitated cutter strips 25,25′ disposed in overlapping relation. The trimming means 24 also has a coupling means 26 connected between the rotatable shaft 23 within the handle 22 and one of the digitated cutter strips 25′ in known manner for reciprocating the digitated strip 25′ relative to the other digitated strip 25 for cutting seaweed disposed between the pair of strips 25, 25′.

In addition, the coupling means 26 of the trimmer unit 15 is articulated on the handle 22 for pivoting the trimming means 24 relative to the handle 22 so that the trimming means 24 can be angled relative to the operator's height to allow a “close shave” to the bottom of the body of water being trimmed of seaweed. To this end, a lever 27 is connected to the coupling means 26 in known manner for manual pivoting of the trimming means 24 relative to the handle 22.

As illustrated, the free end of the handle 22 has a removable cap 28 for protecting the interior of the handle 22 when not in use. This cap 28 is removed when the handle 22 is to be inserted into the coupling device 21 of the extension mount 14.

The trimmer 10 is constructed so that upon starting of the drive motor assembly 13, the shaft 16 of the drive motor assembly 13 causes the shaft 20 within the extension mount 14 to rotate and that shaft 20, in turn, causes the shaft 23 of the trimmer unit 15 to rotate. The rotation of the shaft 23 of the trimmer unit 15 is transferred by the coupling means 26 to cause the digitated strip 25′ to reciprocate.

For ease of use, the seaweed trimmer 10 is provided with a strap 29 that is detachably connected to a clip 30 on the housing 17 of the drive motor assembly 13 for suspending the seaweed trimmer 10 from the body of the operator 11. Also, a rigid J-shaped handle 31 is adjustably mounted on the housing 17 of the drive motor assembly 13 for manual grasping thereof during manual operation of the seaweed trimmer 10 by the operator 11.

In order to reduce the risk of corrosion, a corrosion inhibiting grease or similar lubricant (not shown) is packed or sprayed into each of drive motor assembly 13, extension mount 14 and trimmer unit 15. Alternatively, or in addition, at least the extension mount 14 and the trimmer unit 15 are made of corrosion resistant materials, such as, a suitable plastic, stainless steel, or the like.

When in use, the operator stands in a body of water and by using the lever 27, adjusts the angle of the trimming means 24 relative to the height of the operator 11 and the depth at which trimming is to take place.

After activating the drive motor assembly 13, the trimming means 24 is submerged into the water to begin trimming of the seaweed on the bottom of the water using a semi-circular motion while keeping the weight of the trimmer 10 on the shoulders of the operator 11 via the strap 28.

The seaweed that is trimmed may be gathered and harvested as compost or may be allowed to sink and decay.

The seaweed trimmer 10 offers several advantages over previously known techniques for removing seaweed. First, by using a gasoline powered drive motor assembly 13 instead of an electrically powered device, one avoids electrocution while standing in the water and there are no operating constraints in terms of where the trimmer 10 can be used since the trimmer is not tethered. Further, the use of a gasoline-powered assembly obtains more power than if constructed as an electric tool.

By using a reciprocating cutter strips instead of a rotating cutter, short cutting strokes are obtained with a sharp blade that is unaffected by water. Rotating blades basically do not work well under water because they foul too easily and the seaweed wraps around them rendering them useless. Also, rotating blades are more dangerous than reciprocating cutters due to exposed cutting surfaces. Reciprocating blades are shielded and do less damage to body parts than rotating blades.

The articulated coupling means 26 on the trimmer unit 15 allows people of most any height to use the trimmer 10 with the cutter strips 25, 25′ parallel to the water bottom, which is key to allowing the trimmer 10 to “give a close shave”.

By using the extension mount 14, additional lengths may be added if one needed to trim seaweed in deeper water. Of note, seaweed that needs to be pruned does not normally grow in water much deeper than 10 feet.

The articulated coupling means 26 and extension mounts allow an operator to cut right in front in a semi-circular motion while carrying the weight of the trimmer 10 on his/her shoulders via a strap. The operator can “see what you are doing” with this trimmer, as opposed to cutting blindly.

Being able to use the trimmer 10 while in the water allows the operator to take the weight of the trimmer off his/her body. Likewise, by using a powerful cutting tool, the back and arm strain associated with ineffective push/pull cutting associated with traditional “seaweed rakes” or “push/pull”-type manual cutting devices can be avoided.

The trimmer 10 may be constructed to be more resistant to corrosion, particularly during storage between uses, or during use in salt water. Salt-water operation and subsequent storage will cause rapid corrosion. Hence, it would be desirable to make the whole trimmer 10 of corrosion-resistant materials, such as, stainless steel, Nylon, Teflon, and the like.

The invention thus provides a relative simple device for efficiently and quickly trimming seaweed and sea grasses from the bottoms of a body of water in an environmentally friendly manner.

Further, the invention provides a seaweed trimmer that is easy to use by one adult operator and that is easy to maintain.

What is claimed is:

1. A seaweed trimmer comprising
a drive motor assembly having a rotatable drive shaft;
an extension mount including a tubular housing and a rotatably mounted shaft within said housing, said shaft being coupled to said drive shaft of said drive motor assembly; and
a trimmer unit having an elongated handle, a rotatable shaft within said handle coupled to said shaft of said extension mount for rotation therewith, a trimming means having a pair of elongated digitated strips disposed in overlapping relation and a coupling means connected between said rotatable shaft within said handle and one of said digitated strips for reciprocating said one digitated strip relative to the other of said digitated strips for cutting seaweed disposed between said pair of strips.

2. A seaweed trimmer as set forth in claim 1 wherein said coupling means is articulated on said handle for pivoting said trimming unit relative to said handle.

3. A seaweed trimmer as set forth in claim 2 further comprising a lever connected to said coupling means for manual pivoting of said trimming means relative to said handle.

4. A seaweed trimmer as set forth in claim 1 further comprising a strap connected to said drive motor assembly for suspending the seaweed trimmer from the body of an operator.

5. A seaweed trimmer as set forth in claim 1 further comprising a rigid handle adjustably mounted on said drive motor assembly for manual grasping thereof during manual operation of the seaweed trimmer.

6. A seaweed trimmer as set forth in claim 1 wherein said drive motor assembly is gasoline driven.

7. A seaweed trimmer as set forth in claim 1 wherein said shaft of said trimmer is removably coupled to said shaft of said extension mount.

8. A seaweed trimmer as set forth in claim 1 further comprising a corrosion inhibiting grease in each of drive motor assembly, said extension mount and said trimmer unit.

9. A seaweed trimmer as set forth in claim 1 wherein at least said extension mount and said trimmer unit are made of corrosion resistant materials.
